(19) United States
(12) Patent Application Publication
(10) Pub. No.: US 2014/0067092 A1
(43) Pub. Date: Mar. 6, 2014

(54) ADAPTIVE WORK CYCLE CONTROL SYSTEM

(71) Applicant: CATERPILLAR INC., Peoria, IL (US)

(72) Inventors: Rustu CESUR, Lombard, IL (US); Bryan J. HILLMAN, Peoria, IL (US); Aleksandar M. EGELJA, Naperville, IL (US)

(73) Assignee: Caterpillar Inc., Peoria, IL (US)

(21) Appl. No.: 13/713,988

(22) Filed: Dec. 13, 2012

Related U.S. Application Data
(60) Provisional application No. 61/695,470, filed on Aug. 31, 2012.

(51) Int. Cl. G05B 15/02

(52) U.S. Cl. CPC G05B 15/02
USPC 700/83; 700/275

(57) ABSTRACT

A control system is disclosed for use with an excavation machine. The control system may have a work tool, an operator input device to receive input indicative of a desired movement of the work tool, at least one actuator, and at least one sensor associated with at least one of the work tool and the at least one actuator. The control system may also have a controller in communication with the operator input, the at least one actuator, and the at least one sensor. The controller may be configured to make a classification of a current operation of the machine as one of a plurality of known operations based on a signal from at least one of the operator input device and the at least one sensor. The controller may be further configured to adjust an operational parameter of the at least one actuator based on the classification.

### RELATED APPLICATIONS

This application is based on and claims the benefit of priority from U.S. Provisional Application No. 61/695,470 by Rustu CESUR et al., filed Aug. 31, 2012, the contents of which are expressly incorporated herein by reference.

### TECHNICAL FIELD

The present disclosure relates generally to a control system, and more particularly, to an adaptive work cycle control system.

### BACKGROUND

Excavation machines, for example hydraulic excavators, dragline excavators, wheel loaders, and front shovels operate according to well known cycles to excavate and load material onto nearby haul vehicles. A typical cycle includes a dig segment, a swing-to-truck segment, a dump segment, and a swing-to-dig segment. During each of these segments, the excavation machine performs differently and is subjected to different loads. For example, during a dig segment, high forces and high precision are required to push an empty tool into the material at an optimum attack angle, while during a swing-to-truck segment, high accelerations and high velocities are required for use with a loaded work tool. During a swing-to-dig segment, lower accelerations, high velocities, and less precision are required for use with an empty work tool. As such, the excavation machine is often controlled differently according to what segment of the cycle is currently being completed. In addition, the way that the machine is controlled during each segment can affect productivity of the machine.

Historically, it was the operator's responsibility to control the machine differently during each segment in order to enhance machine performance. For example, the operator was responsible for estimating loading conditions of the machine's work tool and responsively affecting acceleration, velocity, and/or force of the work tool to best achieve specific goals of the machine. Unfortunately, an unskilled operator may not be capable of estimating the loading conditions and/or of properly affecting acceleration, velocity, and force of the work tool. In these situations, machine productivity and/or efficiency decreases. In addition, as machines become more complicated, it may be too interruptive for the operator to continue to perform these functions. And many of today's machines are remotely or autonomously controlled.

One attempt to increase productivity and efficiency of an earth moving machine is disclosed in U.S. Pat. No. 5,955,706 of Fonkalsrud et al. that issued on Sep. 21, 1999 (the '706 patent). The '706 patent provides a method and apparatus for determining the work cycle of an earth moving machine. Sensing devices are provided for determining displacement of tilt and lift cylinders, pressures of the lift cylinders, and a travel direction of the machine. A process system is also provided for receiving signals from the sensing devices, determining a current segment of the work cycle based on the signals, and determining a next segment of the work cycle.

Although the method and apparatus of the '706 patent may provide information useful to help improve the productivity and efficiency of an earth moving machine, it may still be less than optimal. In particular, the '706 patent does not provide control procedures or instructions that will be followed as a result of the acquired information. Accordingly, it may still be left up to the operator to manually adjust control of the machine.

The disclosed control system is directed to overcoming one or more of the problems set forth above.

### SUMMARY

One aspect of the present disclosure is directed to a control system. The control system may include a work tool, an operator input device configured to receive input indicative of a desired movement of the work tool, at least one actuator configured to move the work tool, and at least one sensor associated with at least one of the work tool and the at least one actuator. The control system may also include a controller in communication with the operator input device, the at least one actuator, and the at least one sensor. The controller may be configured to make a classification of a current operation of the machine as one of a plurality of known operations based on a signal from at least one of the operator input device and the at least one sensor. The controller may be further configured to adjust an operational parameter of the at least one actuator based on the classification.

Another aspect of the present disclosure is directed to a method of controlling a work tool. The method may include receiving operator input indicative of a desired work tool movement, and controlling an actuator to move the work tool based on the input. The method may also include generating a signal indicative of an actual work tool movement, and making a classification of a current operation of the work tool as one of a plurality of known operations based on at least one of the operator input and the signal. The method may further include adjusting an operational parameter of the at least one actuator based on the classification.

### BRIEF DESCRIPTION OF THE DRAWINGS

FIG. 1 is a diagrammatic illustration of an exemplary disclosed machine;

FIG. 2 is a schematic illustration of an exemplary disclosed control system that may be used with the machine of FIG. 1; and

FIG. 3 is an exemplary disclosed operation that may be performed by the control system of FIG. 2.

### DETAILED DESCRIPTION

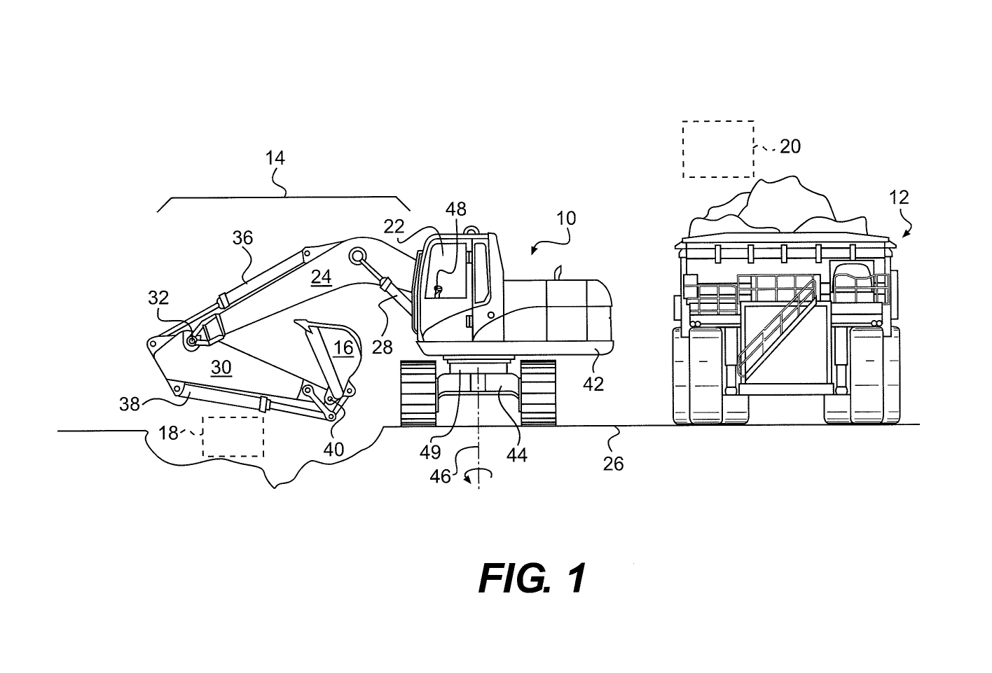

FIG. 1 illustrates an exemplary machine 10 having multiple systems and components that cooperate to excavate and load earthen material onto a nearby haul vehicle 12. In one example, machine 10 may embody a hydraulic excavator. It is contemplated, however, that machine 10 may embody another type of excavation machine such as a backhoe, a front shovel, a dragline excavator, or another similar machine. Machine 10 may include, among other things, an implement system 14 configured to move a work tool 16 between a dig location 18 within a trench and a dump location 20 over haul vehicle 12, and an operator station 22 for manual control of implement system 14.

Implement system 14 may include a linkage structure acted on by fluid actuators to move work tool 16. Specifically, implement system 14 may include a boom 24 that is vertically pivotal relative to a work surface 26 by a pair of adjacent, double-acting, hydraulic cylinders 28 (only one shown in FIG. 1). Implement system 14 may also include a stick 30 that is vertically pivotal about a horizontal axis 32 by a single, double-acting, hydraulic cylinder 36. Implement system 14 may further include a single, double-acting, hydraulic cylinder 38 operatively connected to work tool 16 to pivot work tool 16 vertically about a horizontal pivot axis 40. Boom 24 may be pivotally connected to a frame 42 of machine 10. Frame 42 may be pivotally connected to an undercarriage member 44, and swung about a vertical axis 46 by a swing motor 49. Stick 30 may pivotally connect boom 24 to work tool 16 by way of pivot axes 32 and 40. It is contemplated that a greater or lesser number of fluid actuators may be included within implement system 14 and/or connected in a manner other than described above, if desired.

Numerous different work tools 16 may be attachable to a single machine 10 and controllable via operator station 22. Work tool 16 may include any device used to perform a particular task such as, for example, a bucket, a fork arrangement, a blade, a shovel, or any other task-performing device known in the art. Although connected in the embodiment of FIG. 1 to pivot relative to machine 10, work tool 16 may alternatively or additionally rotate, slide, swing, lift, or move in any other manner known in the art.

Operator station 22 may be configured to receive input from a machine operator indicative of a desired work tool movement. Specifically, operator station 22 may include one or more operator input devices 48 embodied as single or multi-axis joysticks located proximal an operator seat (not shown). Operator input devices 48 may be proportional-type controllers configured to position and/or orient work tool 16 by producing a work tool position signal that is indicative of a desired work tool speed and/or force in a particular direction. The position signal may be used to actuate any one or more of hydraulic cylinders 28, 36, 38 and/or swing motor 49. It is contemplated that different operator input devices may alternatively or additionally be included within operator station 22 such as, for example, wheels, knobs, push-pull devices, switches, pedals, and other operator input devices known in the art.

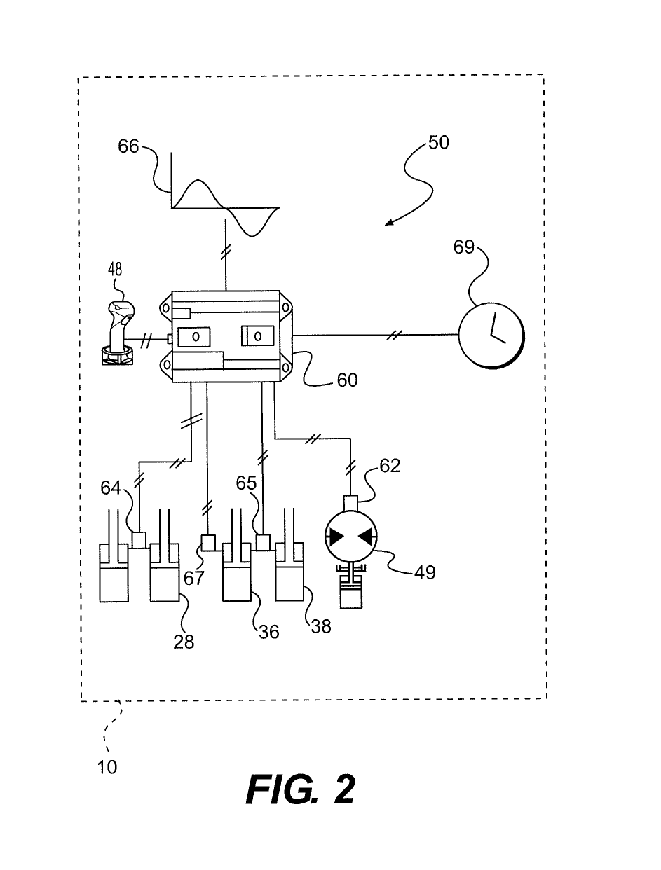

As illustrated in FIG. 2, machine 10 may include a control system 50 configured to monitor, classify, and control movements of work tool 16 (referring to FIG. 1). In particular, hydraulic control system 50 may include a controller 60 in communication with a plurality of sensors and with input device 48. In the exemplary disclosed embodiment, controller 60 is in communication with a first sensor 62, a second sensor 64, a third sensor 65, and a fourth sensor 67. It should be noted, however, that controller 60 could be in communication with a greater or less number of sensors, if desired. Based on input received from any one or all of these sensors and/or from input device 48, controller 60 may be configured to classify a current operation of machine 10 as one of a plurality of known operations. For example, the operation may be classified as one of a dig operation, a swing-to-truck operation, a dump operation, and a swing-to-dig operation, as will be described in more detail below. It is contemplated that controller 60 may alternatively classify the current operation of machine 10 as another operation known in the art, if desired. Controller 60 may then regulate machine 10 differently based on the classified operation.

Controller 60 may embody a single microprocessor or multiple microprocessors that include a means for performing an operation of control system 50. Numerous commercially available microprocessors can be configured to perform the functions of controller 60. It should be appreciated that controller 60 could readily be embodied in a general machine microprocessor capable of controlling numerous machine functions. Controller 60 may include a memory, a secondary storage device, a processor, and any other components for running an application. Various other circuits may be associated with controller 60 such as power supply circuitry, signal conditioning circuitry, solenoid driver circuitry, and other types of circuitry.

One or more maps 66 relating signals from sensors 62-67 and/or input device 48 to the different operations of the typical excavation work cycle may be stored within the memory of controller 60. Each of these maps may include a collection of data in the form of tables, graphs, and/or equations. In one example, threshold speeds associated with the start and/or end of one or more of the operations may be stored within the maps. In another example, threshold forces associated with the start and/or end of one or more of the operations may be stored within the maps. In yet another example, a speed and/or a force of work tool 16 may be recorded into the maps and subsequently analyzed by controller 60 during operation classification of the excavation work cycle. In a final embodiment, a pattern of movements received via input device 48 may be related to particular operations and stored in the maps of controller 60. Controller 60 may be configured to allow the operator of machine 10 to directly modify these maps and/or to select specific maps from available relationship maps stored in the memory of controller 60 to affect operation classification. It is contemplated that the maps may additionally or alternatively be automatically selectable based on modes of machine operation, if desired.

First sensor 62 may be associated with the generally horizontal swinging motion of work tool 16 imparted by swing motor 49 (i.e., the motion of frame 42 relative to undercarriage member 44). Specifically, first sensor 62 may be a rotational position or speed sensor associated with the operation of swing motor 49, an angular position or speed sensor associated with the pivot connection between frame 42 and undercarriage member 44, a local or global coordinate position or speed sensor associated with any linkage member connecting work tool 16 to undercarriage member 44 or with work tool 16 itself, a pressure sensor associated with swing motor 49, or any other type of sensor known in the art that generates a signal indicative of a swing position, acceleration, speed, pressure, and/or force of machine 10. This signal may be sent to controller 60 for further processing. It is contemplated that controller 60 may derive any number of different parameters based on the signal from first sensor 62 and an elapsed period of time (e.g., a time period tracked by an internal or external timer 69), if desired.

Second sensor 64 may be associated with the pivoting motion of work tool 16 imparted by hydraulic cylinders 28 (i.e., associated with the lifting and lowering motions of boom 24 relative to frame 42). Specifically, second sensor 64 may be an angular position or speed sensor associated with a pivot joint between boom 24 and frame 42, a displacement sensor associated with hydraulic cylinders 28, a local or global coordinate position or speed sensor associated with any linkage member connecting work tool 16 to frame 42 or with work tool 16 itself, a pressure sensor associated with hydraulic cylinders 28, or any other type of sensor known in the art that generates a signal indicative of a pivoting position, acceleration, speed, and/or force of boom 24. This signal may be sent to controller 60 for further processing. It is contemplated that controller 60 may derive any number of different parameters based on the signal from second sensor 64 and an elapsed period of time (e.g., a time period tracked by timer 69), if desired.

Third sensor 65 may be associated with the pivoting motion of work tool 16 imparted by hydraulic cylinder 38. Specifically, third sensor 65 may be an angular position or speed sensor associated with a pivot joint between work tool 16 and stick 30, a displacement sensor associated with hydraulic cylinder 38, a local or global coordinate position or speed sensor associated with any linkage member connecting work tool 16 to stick 30 or with work tool 16 itself, a pressure sensor associated with hydraulic cylinder 38, or any other type of sensor known in the art that generates a signal indicative of a pivoting position, acceleration, speed, and/or force of work tool 16. This signal may be sent to controller 60 for further processing. It is contemplated that controller 60 may derive any number of different parameters based on the signal from third sensor 65 and an elapsed period of time (e.g., a time period tracked by timer 69), if desired.

Fourth sensor 67 may be associated with the pivoting motion of stick 30 imparted by hydraulic cylinder 36. Specifically, fourth sensor 67 may be an angular position or speed sensor associated with a pivot joint between boom 24 and stick 30, a displacement sensor associated with hydraulic cylinder 36, a local or global coordinate position or speed sensor associated with any linkage member connecting boom 24 to stick 30 or with stick 30 itself, a pressure sensor associated with hydraulic cylinder 36, or any other type of sensor known in the art that generates a signal indicative of a pivoting position, acceleration, speed, and/or force of stick 30. This signal may be sent to controller 60 for further processing. It is contemplated that controller 60 may derive any number of different parameters based on the signal from fourth sensor 67 and an elapsed period of time (e.g., a time period tracked by timer 69), if desired.

Controller 60 may classify a current excavation operation as one of the four different operations typically performed by machine 10 based on signals received from sensors 62-67 and/or input device 48 and based on the maps stored in memory. In some embodiments, controller 60 may classify the excavation operation based on multiple different conditions being simultaneously or sequentially satisfied, for example one condition associated with the swing motion measured by sensor 62, one condition associated with the pivoting motion measured by sensor 64, one condition associated with the pivot motion measured by sensor 65, one condition associated with the pivot motion measured by sensor 67, and/or one condition associated with a pattern of input movements received from the operator via input device 48. For example, controller 60 may classify the current excavation operation as the dig operation or the swing-to-truck operation when a current swing speed of machine 10 falls below or exceeds a percent of a maximum swing speed, when the pivot speed falls below or exceeds a threshold speed value, when the pivot force is less or greater than a threshold value, and/or when the pattern of input from the operator matches or nearly matches a stored input pattern. The other operations of machine 10 may be classified in a similar manner. The maximum and/or threshold speeds and forces, as well as the pattern of inputs, may vary based on a size of machine 10 and an application thereof.

In some situations, it may be beneficial to adjust machine operation based on the current and/or anticipated operation of machine 10. For example, when raising boom 24 with a fully loaded work tool 16 (e.g., during a dig operation), it may be desirable to increase the acceleration limits imposed on the extending movement of hydraulic cylinders 28 to enhance machine efficiency and/or productivity. In contrast, high acceleration during boom lowering of an empty work tool 16 (e.g., during a return-to-trench segment) could cause work tool 16 to bounce uncontrollably. Accordingly, controller 60 may be configured to affect operational parameters of machine 10 differently based on the classified operation.

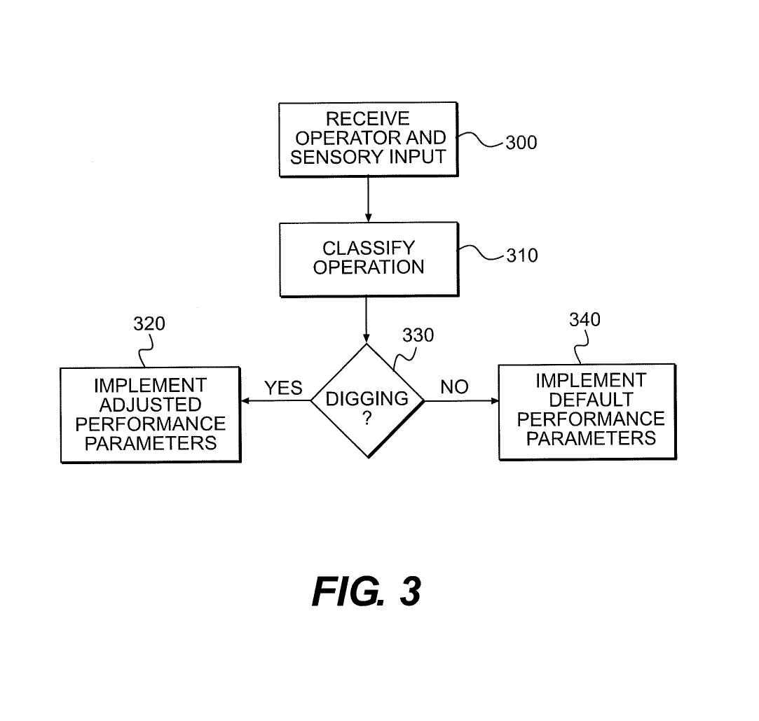

FIG. 3 illustrates an exemplary method performed by controller 60. FIG. 3 will be discussed in more detail below to further explain the disclosed concepts.

### INDUSTRIAL APPLICABILITY

The disclosed control system may be applicable to any excavation machine that performs a substantially repetitive work cycle. The disclosed control system may promote machine control by classifying current operations of the machine and, based on the classification, affecting machine performance. Operation of control system 50 will now be described with respect to FIG. 3.

During operation of machine 10, controller 60 may receive operator and sensory input from input device 48 and sensors 62-67, respectively (Step 300). As described above, this input may include, among other things, a pattern of movements of input device 48 (e.g., a history of displacement positions, displacement directions, displacement velocities, displacement accelerations, etc.) and/or signals indicative of forces, angular positions, swing speeds, pivot speeds, pivot forces, velocities, and accelerations of work tool 16 as imparted by hydraulic cylinders 28, 36, 38, and swing motor 49. Controller 60 may then compare the received operator and sensory input to maps 66 stored in memory to classify the current operation as one of a plurality of known operations (Step 310). The plurality of known operations may be associated with a typical excavation cycle frequently performed by machine 10 and include, for example, a digging operation, a swing-to-truck operation, a dumping operating, and a swing-to-dig operation. It is contemplated, however, that the plurality of known operations may include additional, fewer, and/or different operations, if desired.

Controller 60 may then determine if the current operation is an operation that has been established as requiring or otherwise benefiting from adjustment of particular performance parameters. For example, controller 60 may determine if the current operation is a digging operation (Step 330), which may be known to benefit from increased acceleration. If the current operation is not one of the established operations that may require or otherwise benefit from performance parameter adjustment, controller 60 may implement a default set performance parameters (e.g., a base acceleration, a base force, a base range of motion, etc.) during control of machine 10 (Step 340). Otherwise, controller 60 may implement an adjusted set of performance parameters (Step 320). The adjusted set of performance parameters may include, for example, a higher or lower acceleration rate, a higher or lower overall speed, a higher or lower force, a higher or lower range of motion, etc.

In the disclosed embodiment, the adjusted set of performance parameters may include values that are multiples of values contained within the default set of parameters. For example, when the current operation is classified as a swing-to-dig operation where work tool 16 is generally empty, the acceleration rates, velocities, and or maximum force parameters associated with control of hydraulic cylinders 28, 36, 38, and/or swing motor 49 may take on default values. But when the current operation is classified as a digging operation, the acceleration rates, velocities, and/or maximum force parameters may take on values that are multiples of the default values. For example, in one non-limiting example, the operational parameters associated with a digging operation may take on values that are about three or more times the default values.

Several benefits may be associated with the disclosed control system. First, because controller 60 may classify the current excavation operation according to speeds, forces, ranges of motion, and/or operator input, variability in the excavation process may be accounted for. And, because controller 60 may adapt its regulation of machine actuators based on the classification, performance of machine 10 during each operation may be enhanced. This may be particularly beneficial during heavily loaded operations, for example during digging and/or swing-to-truck operations where boom 24 is raising under heavy load and could benefit from increased acceleration, and during empty raising or lowering of boom 24 where the improvement in controllability is desired. The disclosed control system may be equally applicable to manned and unmanned machines.

It will be apparent to those skilled in the art that various modifications and variations can be made to the disclosed control system. Other embodiments will be apparent to those skilled in the art from consideration of the specification and practice of the disclosed control system. It is intended that the specification and examples be considered as exemplary only, with a true scope being indicated by the following claims and their equivalents.

What is claimed is:

1. A control system for a machine, comprising:
a work tool;
an operator input device configured to receive input indicative of a desired movement of the work tool;
at least one actuator configured to move the work tool;
at least one sensor associated with at least one of the work tool and the at least one actuator; and
a controller in communication with the operator input device, the at least one actuator, and the at least one sensor, the controller being configured to:
make a classification of a current operation of the machine as one of a plurality of known operations based on a signal from at least one of the operator input device and the at least one sensor; and
adjust an operational parameter of the at least one actuator based on the classification.

2. The control system of claim 1, wherein:
the plurality of known operations includes a digging operation;
when the current operation is classified as one of the plurality of known operations other than the digging operation, the controller is configured to implement a default set of operational parameters; and
when the current operation is classified as the digging operation, the controller is configured to implement an adjusted set of operational parameters.

3. The control system of claim 2, wherein the adjusted set of operational parameters includes values that are multiples of values of the default set of operational parameters.

4. The control system of claim 1, wherein the controller is configured to make the classification of the current operation of the machine based on a threshold speed associated with one or both of a start and an end of the current operation.

5. The control system of claim 1, wherein the controller is configured to make the classification of the current operation of the machine based on a threshold force associated with one or both of a start and an end of the current operation.

6. The control system of claim 1, wherein the controller is configured to make the classification of the current operation of the machine based on both a speed and a force of the work tool.

7. The control system of claim 1, wherein the controller is configured to make the classification of the current operation of the machine based on a pattern of operator inputs received via the operator input device.

8. The control system of claim 1, wherein the controller is configured to make the classification of the current operation of the machine by referencing a value of the signal to a map of data stored in a memory, the map of data relating signal values to the plurality of known operations.

9. The control system of claim 1, wherein the controller is configured to make the classification of the current operation of the machine as one of a plurality of known operations based further on an elapsed period of time.

10. The control system of claim 1, wherein the at least one sensor is configured to generate a signal indicative of one or more of pivoting position, angular position, local coordinate position, global coordinate position, acceleration, swing speed, speed, force, or pressure associated with at least one of the work tool and the at least one actuator.

11. A method of controlling a work tool, comprising:
receiving operator input indicative of a desired work tool movement;
controlling an actuator to move the work tool based on the input;
generating a signal indicative of an actual work tool movement;
making a classification of a current operation of the work tool as one of a plurality of known operations based on at least one of the operator input and the signal; and
adjusting an operational parameter of the actuator based on the classification.

12. The method of claim 11, wherein adjusting an operational parameter includes:
implementing a default set of operational parameters when the current operation of the work tool is classified as a first operation; and
implementing an adjusted set of operational parameters when the current operation of the work tool is classified as a second operation.

13. The method of claim 12, wherein:
the second operation is a digging operation; and
the first operation is any operation other than the digging operation.

14. The method of claim 12, wherein implementing an adjusted set of operational parameters includes implementing operational parameters having values that are multiples of values of the default set of operational parameters.

15. The method of claim 14, wherein implementing the adjusted set of operational parameters includes implementing operational parameters having values that are about three times the values of the default set of operational parameters.

16. The method of claim 11, wherein making the classification of the current operation of the work tool includes making the classification based on a threshold speed associated with one or both of a start and an end of the current operation.

17. The method of claim 11, wherein making the classification of the current operation of the work tool includes making the classification based on a threshold force associated with one or both of a start and an end of the current operation.

18. The method of claim 11, wherein making the classification of the current operation of the work tool includes making the classification based on both a speed and a force of the work tool.

19. The method of claim 11, wherein making the classification of the current operation of the work tool includes making the classification based on a pattern of operator inputs.

20. A method of controlling a work tool, comprising:
receiving operator input indicative of a desired work tool movement;
controlling a hydraulic cylinder to raise or lower the work tool based on the input;
generating a signal indicative of an actual work tool movement;
making a classification of a current operation of the work tool as a digging operation based on at least one of a pattern of the operator input and the signal; and
increasing an acceleration limit of the hydraulic cylinder to about three times a base value corresponding to the classification.
